(19) United States
(12) Patent Application Publication
(10) Pub. No.: US 2005/0093979 A1
(43) Pub. Date: May 5, 2005

(54) SYSTEM FOR CREATING AND STORING DIGITAL IMAGES

(76) Inventor: John C. Tsai, Saratoga, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/905,669

(22) Filed: Jan. 14, 2005

Related U.S. Application Data
(60) Provisional application No. 60/481,898, filed on Jan. 14, 2004.

(51) Int. Cl. H04N 5/225

(52) U.S. Cl. 348/207.99

(57) ABSTRACT

Systems, methods, and products created by the methods that create a photo-magnetic image of an object in photo-magnetic stock. A source provides a data signal that is representative of a digital image. The source may particularly include a lens and digital sensor in the manner of a digital camera, or may particularly include an interface to receive the data signal from an external system where it has been captured, stored, or generated. A first coding unit then optically writes the data signal into the photo-magnetic stock and a second coding unit magnetically writes the data signal into the photo-magnetic stock.

### CROSS-REFERENCE TO RELATED APPLICATIONS

This application claims the benefit of U.S. Provisional Application No. 60/481,898, filed Jan. 14, 2004, hereby incorporated by reference in its entirety.

### TECHNICAL FIELD

The present invention relates generally to image processing and storage, and more particularly to optical and magnetic systems for such.

### BACKGROUND ART

Digital photography and other forms of digital image generation wherein the digital images are stored for later use are becoming very popular. For example, even many cellular telephones today come equipped with a digital picture or even a digital movie taking capability. Throughout this disclosure, we use the term “digital camera” to generally represent all devices capable of capturing digital images or “photographs” of objects. Some examples of such devices include digital cameras per se, devices equipped with a digital camera-like capability, such as microscopes or telescopes, and devices such as cellular telephones, personal digital assistants (PDAs), computer cameras, etc., that can capture a digital image. We also occasionally use the term “digital imager” to generally represent all devices capable of generating digital images of objects. Some examples of such devices include computers and game consoles. For instance, a computer can generate a digital image of a page of a document created in a word processor, and a game console can generate a digital image of a scene in an cartoon-like animation. The distinction between digital cameras and digital imagers is not of major importance here, since our primary interest is obtaining digital images, by capturing them or generating them, and then storing them. One other term we particularly use herein is “object,” to generally represent the subject matter that can appear in a digital image.

FIG. 1 (background art) is a schematic depiction of the major elements in a typical digital camera 10 that is being used to photograph an object 12. The digital camera 10 includes a lens unit 14, a digital sensor 16 that produces one or more data signals 18, and a dataport 20. Since the digital sensor 16 is light sensitive, the elements are contained in a light-tight housing 22. Optionally, the digital camera 10 may also have an image processor 24 and a viewing screen 26.

[Note, the image processor 24 and viewing screen 26 effectively are a digital imager under the definition stated above. As also noted, however, distinctions with respect to the source of a digital image are largely unimportant here. Digital cameras are used now in our primary examples, and digital imagers are only discussed where considerations particular to them apply.]

Continuing with FIG. 1 and the digital camera 10 depicted there, the lens unit 14 can be essentially the same as devices that have long been used in non-digital cameras. For example, it may have focusing capability, the ability to limit entering light (“f-stop” setting ability), and it can be a zoom or fixed focal length lens.

The digital sensor 16 most likely to be used today is closely related to integrated circuit memories, although other devices are starting to become available as well. In use, light from the object 12 is received and projected by the lens unit 14 onto the digital sensor 16, which then converts that light into memory states that are read and become data in the data signal 18.

The data signal 18 can then be provided to the dataport 20, typically when the user presses a “shutter button” directing this. The dataport 20 is simply a mechanism to, immediately or at some later point in time, communicate the data signal 18, as itself or as a file of data based on it, from the digital camera 10 to an outside system (not shown).

Many variations of the dataport 20 are in current use. A few send the data signal 18 to an outside system immediately. Others convert the data signal 18 into a local file that is stored and may, or may not, ultimately be communicated to an outside system. Many dataports 20 today include file storage units that are able to store multiple files (i.e., multiple digital images). Various types of file storage units can be used, with common examples today including static and low power integrated circuit based devices and small magnetic and optical disk drive devices. The contents of such a file storage unit can later be communicated, all or in part, to the outside system. This can be via a communications link or by physically moving the file storage unit from the dataport 20 to the outside system. Collectively, however, the dataport 20 is herein treated as including whatever communications link or file storage unit is used.

The optional image processor 24 and viewing screen 26 permit a user of the digital camera 10 to review a digital image and decide whether to keep it, retake it. etc. Basically, the image processor 24 receives the data signal 18 and from it displays an image representing the digital photograph on the viewing screen 26. In digital cameras 10 lacking these elements, an outside system may be used that has features to similarly permit reviewing digital images as they are being taken.

The role of the housing 22 is simple. It prevents unwanted light from reaching the digital sensor 16. It also physically contains and protects the other elements of the digital camera 10.

The above discussion of digital cameras is high simplified but it serves to introduce key concepts needed to appreciate and to discuss some major problems that effect digital imaging generally. For example, the users of digital cameras today often have a “crisis in confidence” when using them. They want or need a tangible hardcopy of the digital image immediately and digital cameras do not provide this or lend what they do provide to easily providing such.

With traditional chemical-film based cameras, “photo finishing” can often be provided immediately or in a timely enough manner for a user's needs. In contrast, with digital cameras “image finishing” is usually not possible until an appreciable time later. Image finishing, i.e., the printing of digital images, therefore still remains a serious issue for many existing and potential users of digital cameras. As a historical matter, image finishing emerged largely as an outgrowth of printing on regular office printers. Such printers are very useful for handling typical office chores, such as word processing or graphics editing (i.e., image finishing for digital imagers), but they usually also require an attached computer system with an appropriate software driver before they can print anything. Office printers can thus provide tangible results in reasonable time for office tasks, but not necessarily for image finishing. Color printers are relatively slow, literally printing one or only a few “dots” at a time, building the ultimate digital image dot-by-dot, line-by-line. Printing from large image files therefore takes appreciable time. In an office environment where size, weight, space, etc., are not major concerns, and where print supplies are easily stocked, and the costs for all of this can be spread across a number of users, office printers may be adequate for image finishing. But this usually is not the type of environment where a digital camera is used.

Photo finishing, i.e., the printing of optically created chemical images, evolved well before image finishing and remains quite different from it. Traditionally, cameras have been mobile devices that users would take with them to whatever they wish to photograph. In response to this, traditional photography evolved a number of photo finishing solutions. First, on-site photo finishing was employed, effectively moving a small version of a photo developing laboratory to or near the site where photographs were being taken. Professional photographers still use such systems sometimes today, for example, to be sure that color balance, lighting, focus, etc. are all correct before making a substantial further investment in time and resources to take additional photographs. On-site photo finishing may also be used to insure that the subject matter has been successfully photographed, say, if it is expensive, difficult, or impossible to return and take new photographs later.

A second major photo finishing advancement was the growth of a major infrastructure to support chemical photo finishing as photography became popular. In almost any city of medium size today a photographer can obtain commercial photo finishing in as little as one hour. One very well known supplier of goods and services in this respect is the Kodak Corporation. And the last major photo finishing advancement was instant developing systems. Well known examples of cameras and films for this have been marketed by the Polaroid Corporation.

Thus, photo finishing and image finishing have evolved very differently and, even in addition to the technical aspects just noted, this is burdensome on users. Many traditional (chemical-film) photographers are not knowledgeable in using computers, or in how or where to obtain image finishing when they are traveling, to the extent that such is even available. This makes their transitioning to digital photography more difficult. New digital photographers are off-put by the “overhead” involved if they simply desire to see the result of their digital photography efforts. After purchasing a digital camera, they are immediately faced with having to buy or obtain access to a computer and a printer (or at least to one of the emerging office printers that directly accepts digital media). Alternately they can rely on a third party to perform image finishing for them, but little commercial infrastructure has emerged to fill this need. Since photography is largely a mobile profession or hobby, new digital photographers are therefore often faced with having to buy a laptop personal computer and one or more color photo printers as well. For instance, a portable, low-quality color photo printer can be taken into the field but it is still desirable to obtain high quality final copies off of a non-portable color photo printer at some point. And associated with these printers is the need to be sure and have an adequate supply of printer ink cartridges and print stock on hand. Aside from the high cost of all of this, its weight and bulk makes travel physically difficult and it can also draw undesired attention from security personnel, customs officials, and thieves.

Other major problems, that have effected digital and traditional photography, are maintaining result quality and result storage. The only “storage media” options in traditional photography are prints, slides, or negatives, and these all inherently degrade over time due to their reliance on chemical-based processes.

Digital photography fairs better, so long as the result is stored as a digital file in non-humanly perceivable form (e.g., in a memory stick, on a hard drive, or burned into a CD or DVD). Once a digital image is “printed,” however, it fairs about the same as a chemical photograph, degrading over time due to the chemical-based media it is then embodied in.

Of course, if the original digital file is available, new digital images can be printed out whenever and in whatever quantity is desired. The problem with this, however, is that the original digital file or a copy of it often is not available. The possessors of such frequently lose or deliberately delete them. In fact, since the original digital file for a digital photograph is typically stored in a memory having a limited capacity, and it usually is deleted to free up capacity for other needs. Even if a copy of the original digital file is made, it is not integrated a tangible print of the digital image in any way, and the likelihood of its loss or intentional deletion is high. The possessors of such files rarely distribute them with printed copies. Thus, for example, a printed digital photograph of an important object, such as a family gathering, fairs no better than a traditional printed photograph. Over time, it fades and the chances of replacing it become less and less.

### DISCLOSURE OF INVENTION

Accordingly, it is an object of the present invention to provide systems, methods, and products produced by the methods for creating and storing digital images.

Briefly, one preferred embodiment of the present invention is a system for creating a photo-magnetic image of an object in photo-magnetic stock. A source provides a data signal that is representative of a digital image. The source may, without limitation thereto, include either a lens and digital sensor in the manner of a digital camera, or an interface to receive the data signal from an external system where it has been captured, stored, or generated. A first coding unit then optically writes the data signal into the photo-magnetic stock and a second coding unit magnetically writes the data signal into the photo-magnetic stock.

An advantage of the present invention is that it permits storing an analog, humanly perceivable optical coding of a digital image as well as an analog or digital machine perceivable magnetic coding of the same digital image.

Another advantage of the invention is that it inherently ties its optical and magnetic codings into one physical object. This facilitates a human viewer seeing at a glance in the optical coding what the magnetic coding contains, and it permits using the magnetic coding and suitable apparatus to reproduce the optical coding repeatedly and with of the same quality as the first optical coding.

Another advantage of the invention is that it uses mature, already widely used technologies that many users are already familiar with.

And another advantage of the invention is that it can be implemented very economically.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended figures of drawings in which:

FIG. 1 (background art) is a schematic depiction of the major elements in a typical digital camera being used to photograph an object.

FIG. 2 is a schematic depiction of an image creator in accord with the present invention that creates a hardcopy photo-magnetic image (PM image) of an object.

FIG. 3 is a flow chart depicting an imaging process in accord with the present invention that may use the image creator in FIG. 2, to create the PM image of the object as well as to perform conventional digital photography operations.

FIG. 4 is a schematic depiction of one standalone image creator that may also be used to create the PM image.

FIG. 5 is a schematic depiction of another standalone image creator that may also be used to create the PM image.

FIG. 6 is a schematic depiction of an integrated image creator that may also be used to create the PM image.

FIG. 7 is a schematic depiction of another standalone image creator that may also be used to create the PM image.

In the various figures of the drawings, like references are used to denote like or similar elements or steps.

### BEST MODE FOR CARRYING OUT THE INVENTION

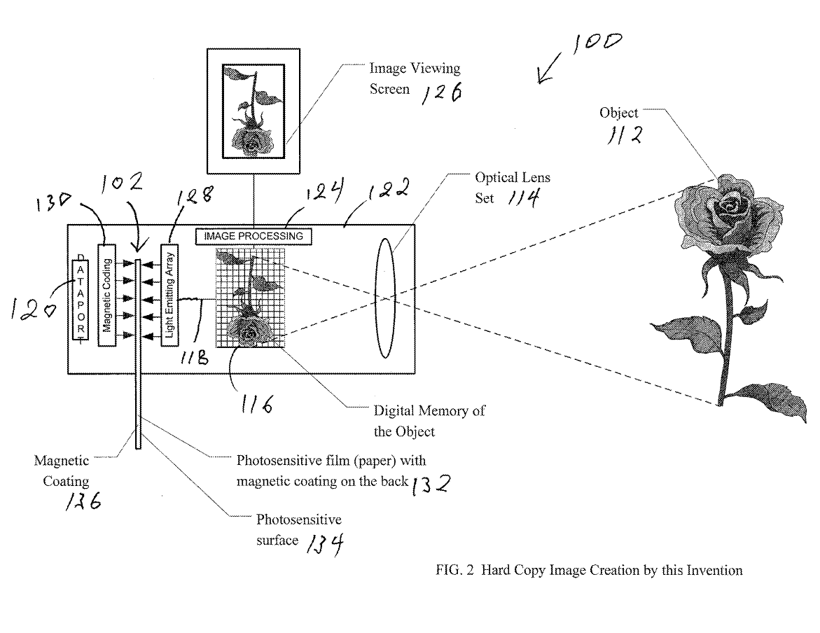

A preferred embodiment of the present invention is a system for creating hardcopies of digital images. As illustrated in the various drawings herein, and particularly in the views of FIG. 2-7, embodiments of the invention are depicted by the general reference characters 100, 200, 300, 400, 500, and 600.

In this invention disclosure, the inventor teaches an apparatus and method that will achieve the above objective. The apparatus embodiments are collectively termed “image creators” and the method embodiments are collectively termed “imaging processes.”

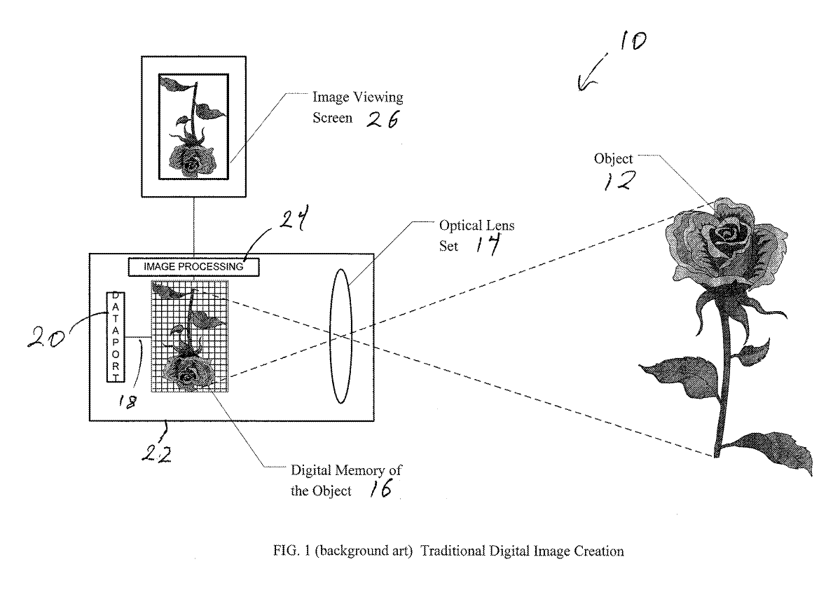

FIG. 2 is a schematic depiction of an image creator 100 that creates a hardcopy photo-magnetic image (PM image 102) of an object 112 (as described in the Background Art section, the term “object” is herein defined to be essentially anything that can be reduced to a visually perceivable two-dimensional digital representation). The image creator 100 includes a lens unit 114, a digital sensor 116 that produces at least one data signal 118, and a dataport 120. Since the digital sensor 116 is light sensitive, these elements are contained in a light excluding housing 122. Optionally, the image creator 100 may further include an image processor 124 and a viewing screen 126. These elements may be essentially similar to elements that have been described above for the conventional digital camera 10 in FIG. 1.

Additionally, in contrast with conventional systems, the image creator 100 includes an optical coding unit 128 and a magnetic coding unit 130. The image creator 100 accepts photo-magnetic stock (PM stock 132) that will ultimately contain the PM image 102. The PM stock 132 includes a photoreceptive surface 134 and a magneto-receptive surface 136 (or sub-surface).

In some embodiments, elements like the magnetic coding unit 130 and the magneto-receptive surface 136 on the PM stock 132 are optional (somewhat making “PM” a misnomer). To facilitate this discussion, however, the exemplary embodiments shown in the figures all include these or equivalent elements.

In other embodiments, the photoreceptive surface 134 or the magneto-receptive surface 136, or both, can be applied to the PM stock 132 in the image creator 100 itself. In the inventor's presently preferred embodiment, the photoreceptive surface 134 uses traditional photo-chemical processes, but printed ink and inkjet processes can also be used apply a visually perceivable image onto the photoreceptive surface 134. Similarly, it is anticipated that most embodiments will have the magneto-receptive surface 136 “manufactured” into the PM stock 132 and that the magnetic coding unit 130 will use an essentially conventional read/write head to, write, read, erase, rewrite, etc. into this media. For example, this can work largely like magnetic ID and prepaid telephone cards do today, having paper or thin plastic substrates that are manufactured with an integral magnetic zone. However, this is also not a requirement. Un-magnetized “ink” can be printed or otherwise bonded (e.g., using printed ink and inkjet processes) onto the PM stock 132 just before or even as the magnetic coding unit 130 is magnetically storing data therein. Alternately, already magnetized “ink” can be printed or otherwise bonded (e.g., using printed ink and inkjet processes) onto the PM stock 132 by the magnetic coding unit 130. Although now largely replaced by optical systems, Magnetic Ink Character Recognition (MICR) systems have traditionally been used to print magnetically and humanly readable characters on bank checks, coupons, etc. The present invention can expand on the basic concept of this, having the magnetic coding unit 130 print data with such an ink onto the PM stock 132 that is magnetically readable but not humanly readable or even perceivable.

In yet other embodiments, the photoreceptive surface 134 and the magneto-receptive surface 136 in the PM stock 132 can be the same and the optical coding unit 128 and the magnetic coding unit 130 can be integrated.

For example, conventional photographic films, plates, and papers operate by exposing a photosensitive material to light and then using chemical processes to remove that material or replace it with another. The amount of the material removed varies and is governed by the intensities and frequencies of the light exposure. These materials, however, can be relatively easily modified to also have magnetic properties. For example, in the chemical developing process wherein the photosensitive material is removed or replaced, magnetic material can coincidentally be proportionately removed as well. If the material is magnetized to begin with, the remaining magnetic strength at any given point in the material after it is “developed” will depend on the light exposure. That is, the material will now be both optically and magnetically coded. Similarly, if the material is not already magnetized, it can now be magnetized and the extent to which it can be magnetized will depend on the light exposure.

As for how magnetic coding in these manners can represent multiple colors, many forms of magnetic recording use three tracks. For example, the credit cards and driver licenses that many of us carry have three magnetically recorded tracks that visually appear to us as one region. This can be used, or still more tracks can be used, with effectively no limitation. So, using one variation of the above as an example, if three magnetic heads are put next to three color ink-jet channels to handle the intensity of each color separately, when the magnetic coding is read back the three channels/tracks can be combined to regenerate the original color of the image.

Another option to integrate the photoreceptive surface 134 and the magneto-receptive surface 136 in the PM stock 132 use an integrated optical coding unit 128 and magnetic coding unit 130 is to print with ink that is both visually pigmented and that is already or that can later be magnetized. For instance, conventional color inkjet printers typically use yellow, cyan, and magenta colored inks (and black). The compounds in these can now include a substance with magnetic properties. As colors are applied, each will then exhibit a visual color-strength and a corresponding magnetic- or magnetizeable-strength. A human viewer then can see the optically coded digital image and a magnetic head can read the magnetically coded digital image.

Returning now to embodiments where the photoreceptive surface 134 and the magneto-receptive surface 136 in the PM stock 132 are distinct, it should be noted that the optical “storage density” of the PM stock 132 can will usually be less than its magnetic storage density, particularly if sophisticated data compression techniques are used in the magnetic coding. Accordingly, an instance of the PM stock 132 can have an optical coding that is humanly perceivable as a conventional 8×10″ picture, yet the magnetic coding of this can occupy a ¼″ strip along one edge of the PM stock 132.

This provides a lot of flexibility. The magneto-receptive surface 136 can simply be smaller than the photoreceptive surface 134, thus saving material. Alternately, the magneto-receptive surface 136 can be used to store data in addition to that stored in the photoreceptive surface 134. Some examples of this are described in passing, later in this discussion.

In use, an image creator 100 performs the same operations as the digital camera 10 in FIG. 1, as well as additional operations. Light from the object 112 is received and projected by the lens unit 114 onto the digital sensor 116. The digital sensor 116 converts this light into memory states that become data in the data signal 118. The data signal 118 is then provided to the dataport 120 and the image processor 24, if present. Additionally, the data signal 118 is provided to the optical coding unit 128 and the magnetic coding unit 130, if present.

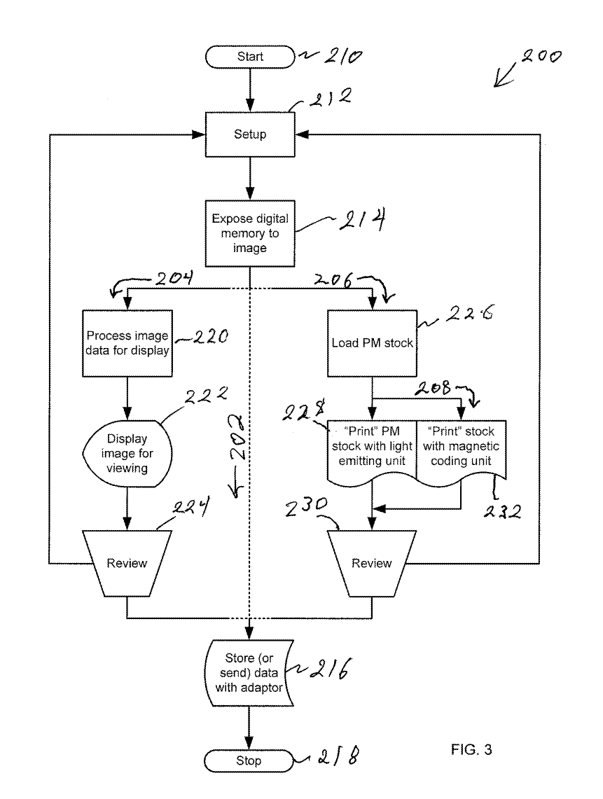

FIG. 3 is a flow chart depicting an imaging process 200 that may use the image creator 100 in FIG. 2, to create the PM image 102 as well as to perform conventional digital photography operations. The imaging process 200 includes four overlapping scenarios 202, 204, 206, 208.

The imaging process 200 starts in a step 210, and in a step 212 any desired setup operations are performed. In a first iteration there may little or no setup desired, so discussion of this is deferred for a few paragraphs. Next, in a step 214, an image of the object 112 is projected onto the digital sensor 116, thus exposing it and causing the data signal 118 to be produced.

Now the scenarios 202, 204, 206, 208 diverge. The most basic case is represented by scenario 202. Here a step 216 follows step 214, and the data signal 118 is stored or communicated onward by the dataport 120 and in a step 218 the imaging process 200 stops.

Of course, scenario 202 does not make for a very useful digital camera, since the user so far has very little control over what ends up going to the dataport 120. For example, the user does not know if the object 112 is being correctly projected onto the digital sensor 116. The projected image may be too big or too small, it may be cut off or offset, it may be too bright or too dark and, particularly, its color balance may not meet the user's expectations or needs.

The most common case today is represented by scenario 204. Here a step 220 follows step 214, and the image processor 124 receives the data signal 118. The image processor 124 “drives” the viewing screen 126, so that it produces a user viewable representation of the data in the data signal 118. In a step 222 this viewable representation is displayed for the user on the viewing screen 126, and in a step 224 the user reviews it and decides whether or not they are satisfied. If so, step 216 and step 218 follow, i.e., the data signal 118 is stored/sent by the dataport 120 and the imaging process 200 stops. Otherwise, if the user is unhappy with what they see on the viewing screen 126, step 212 is returned to and measures can be taken to change things. For instance, the object 112 may be repositioned or illuminated differently, or the lens unit 114 can be zoomed in or out, focused differently, etc. Many iterations may occur, returning to step 212 repeatedly until the user is satisfied with the representation viewed on the viewing screen 126, and then step 216 and step 218 can be performed.

A key point to note here is that the user makes his or her determination based on what they see displayed on the viewing screen 126 and, as is discussed further below, that is not necessarily what goes to the dataport 120 or what later image finishing will look like.

One arrangement in accord with the present invention occurs in scenario 206. Here a step 226 follows either step 214 or step 224 (discussed further presently). In step 226 the PM stock 132 is loaded into the image creator 100. The user will often do this as part of step 212, but depicting this as a separate step here emphasizes that it does not have to occur until just before the stock is “printed,” and this also emphasizes that the image creator 100 can be used just like a conventional digital camera whenever that is desired.

In a step 228 the PM stock 132 is optically “printed.” The data signal 118 is received by the optical coding unit 128 and, based on it, the optical coding unit 128 exposes the photoreceptive surface 134 of the PM stock 132, which is then developed into the visible portion of the PM image 102. Depending upon the particular PM stock 132 used, developing can be performed using chemicals in the packaging of the PM stock 132, or the PM stock 132 can be developed using separate chemicals. For example, the Polaroid Corporation is well known for developing systems using chemicals in film stock packaging and the Kodak Corporation is well known for developing systems using separate chemicals.

In a step 230 the user can visually review the PM image 102 and decide whether they are satisfied with it. If so, step 216 and step 218 can follow, i.e., the data signal 118 can be stored within or sent onward by the dataport 120 and the imaging process 200 stops. Alternately, if the user is not satisfied with the PM image 102, step 212 is returned to and measures can be taken to change things.

Returning to a key point above, in step 224 the user makes a determination based upon what they see on the viewing screen 126, whereas in step 230 the user makes a determination based on what they see in the PM image 102. In the case of the PM image 102, however, the user has a copy equivalent to a conventional photograph. This is a tangible copy that the user may give away immediately or keep. This copy can be viewed without any additional processing or special apparatus and it can be witnessed and even notarized. Quite unlike a digital file, the PM image 102 will be difficult to alter, intentionally or otherwise, and it can pass through airport security scanners and strong electromagnetic fields essentially unscathed. The PM image 102 is also a more true representation of what image finished copies based upon data from the dataport 120 will look actually like. The viewing screen 126 is typically small and subtle problems that are hard or impossible to detect on it are more easily observed in the PM image 102. The viewing screen 126 may also have inherent hardware characteristics that can misrepresent what the data in the data signal 118 will produce in actual image finishing and later viewing conditions. The color balance of the PM image 102 will thus be more true and problems in focus, shadow contrast, etc. can more easily be detected and corrected here. The user can critically review the PM image 102 with a magnifying glass and put it under a different type of illumination, if desired. In sum, the user and others should not have a “crisis in confidence” over the PM image 102.

Another arrangement in accord with the present invention occurs in scenario 208, a slight variation of scenario 206. Typically concurrent with optically printing the PM stock 132 in step 228, a step 232 here magnetically “prints” the data in the data signal 118 into the magneto-receptive surface 136 of the PM stock 132. In this manner, in addition to being a humanly viewable “analog” record, the PM image 102 also becomes a machine readable record (digital or analog, but with digital being advantageous in most cases). This machine readable record can be used to make countless exact duplicates the PM image 102 (as only an analog record, as only a digital record, or as both). If the analog record in the developed photoreceptive surface 134 of the PM image 102 deteriorates over time, a digitally magnetically coded record in the PM image 102 permits printing a fresh copy that is an exact copy (analog and digital) of what was originally present.

As noted, other data can optionally be magnetically recorded into the magneto-receptive surface 136. For instance, the time and date of image capture can automatically be added, but without annoyingly appearing in the photograph itself, where many conventional digital cameras put such information. Since the magneto-receptive surface 136 can have an appreciable storage capacity, additional data can also be added that is not customarily recorded by conventional digital cameras. For example, the settings of the lens unit 114 can be stored automatically. A microphone and circuitry can even be incorporated to the image creator 100 so that the user can record and store verbal comments with each PM image 102, such as what the object 112 is and where or why the picture was taken.

Also noted in passing already, the magneto-receptive surface 136 need not be a true, full surface. In can be one or more zones, say, near one or more edges of the PM stock 132, yet occupying less than a full side of a sheet of the stock. The magneto-receptive surface 136 can also be placed a sub-surface, since reading and writing to it does not require that it be externally accessible. The data bearing magnetic medium can then comprise one or more zones, or comprise a surface equal in size to the physical surface of the PM stock 132. For that matter, complex implementations of the PM stock 132 can be made double-sided or “sandwiched,” by incorporating a first photoreceptive surface 134 with an underlying first magneto-receptive surface 136, a magnetic separation mechanism, and then a second magneto-receptive surface 136 underlying a second photoreceptive surface 134. The magnetic separation mechanism here can be anything that isolates the two magneto-receptive surfaces 136 so that reading or writing one does not interfere with the other. Some examples, without limitation, include systems like those currently used to isolate side-one data from side-two data in cassette tapes, or a then conductive layer (e.g., of aluminum) that is momentarily energized to isolate the two magneto-receptive surfaces 136.

As a digital copy, the PM image 102 has a number of other inherent advantages. For example, it can be mailed or transported by courier service cheaply and it need not attract undue attention. Mail and courier packages containing conventional digital camera memory sticks, flash memory modules, micro-disk drives, and even rigid CD-R or DVD-R optical disks are notoriously subject to damage, theft in transit, and delay for security and customs inspection. The PM image 102, however, will typically have the physical attributes of medium-weight paper stock and the visual content present in the developed photoreceptive surface 134 will generally be of little if any interest to others.

The scenarios 202, 204, 206, 208 can be combined in many embodiments. For example, the user might initially follow scenario 204, iterating as many times as desired, to view rough depictions on the viewing screen 126 and to make any coarse changes desired. The user can then follow scenario 206, with or without scenario 208, also iterating as many times as desired, to view more precise depictions in each PM image 102 and to make any fine changes desired. Then the user can complete scenario 202, finally storing the data in the data signal 118 in the dataport 120 or using it to send that data to an outside system. If the user has employed scenario 208, they may also mail the last, presumably best quality, PM image 102 to their office or home as a backup copy.

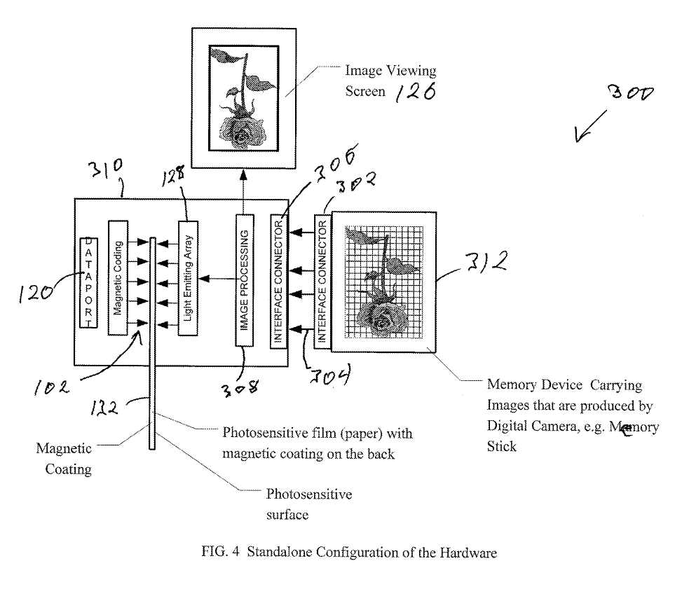

FIG. 4 is a schematic depiction of an image creator 300 that may also be used to create the PM image 102. A number of elements in the image creator 300 may be the same as elements in the image creator 100, so reference numbers are reused where appropriate. The salient difference between the image creator 100 of FIG. 2 and the image creator 300 here is that the image creator 100 is a camera-like system whereas the image creator 300 is standalone printer-like system.

In addition to many elements already described for FIG. 2, the image creator 300 here includes a first interface connector 302, an interface link 304, a second interface connector 306, an image processor 308, and a housing 310. The first interface connector 302 is suitable to receive a memory device 312 that includes stored digital images. This memory device 312 can be from a conventional digital camera, wherein such is often termed a flash memory card, memory stick or micro drive. Since the dataport 120 of the image creator 100 may be one of these devices, or some different removable digital sensor, the memory device 312 here can even be a dataport 120.

The first interface connector 302 communicates via the interface link 304 with the second interface connector 306. The interface link 304 may use any of many currently available protocols, e.g., RS232, RS485, IEEE 394 (also known as Firewire™), USB, IR port, 10/100/1000 BaseT Ethernet, GPIB, GPIL, parallel port, etc., or still another protocol such as a proprietary parallel communications scheme.

The second interface connector 306 here is mounted in the housing 310 and is connected to the image processor 308, while the image processor 308 here is connected to the viewing screen 126 and the optical coding unit 128. Those skilled in the art will readily appreciate that many variations in the image creator 300 are possible. For example, the image processor 308 could be mounted on the housing 310 and have integrated interface capability. It could thus directly retrieve the stored digital images from the memory device 312. Alternately, or additionally, this integrated interface capability in the image processor 308 could simply be used for communications with a dataport 120 in an image creator 100. That is, the image creator 300 can itself be an outside system for an image creator 100.

The image creator 300 has been shown in FIG. 4 with two linked interfaces to emphasize that a wide variety of embodiments are possible. Since there are many types possible for the memory device 312, with flash memory cards, memory sticks and micro drives being just a few of the formats in current use, the second interface connector 306 might be chosen to accept the format that is most common, more robust, least expensive, etc. The first interface connector 302 and the interface link 304 can then be optional, for use only when another format is encountered. The interface link 304 here will still connect or communicate with the second interface connector 306, but can now be recognized and dealt with as if it is a device in the format that the second interface connector 306 accepts. This approach also puts off obsolescence. If a new format emerges, an appropriate new version of the first interface connector 302 can be produced to still use the interface link 304 and the existing image creator 300.

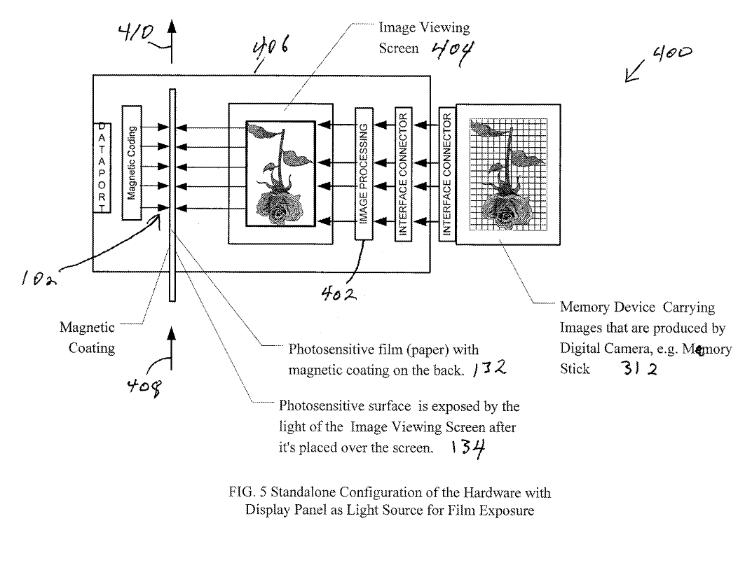

FIG. 5 is a schematic depiction of an image creator 400 that may also be used to create the PM image 102. A number of elements in the image creator 400 may be the same as elements in the image creator 300 and the image creator 100, and like reference numbers are reused where appropriate. The image creator 400 is much like the image creator 300 of FIG. 3 in that it is standalone printer-like system, but it differs in the elements and principles it uses. In addition to like elements already described for FIGS. 2 and 4, the image creator 400 here includes an image processor 402, a viewing screen 404, and a housing 406. However, the image processor 402 here drives just the viewing screen 404, and the viewing screen 404 then functions as the optical coding unit used to expose the photoreceptive surface 134 of the PM stock 132.

The image viewing devices used in traditional digital cameras, and in electronic devices generally, are often subject to a number of tradeoffs. For example, the image viewing device is a relatively expensive component and it may consume considerable power. This adds weight, increases size, etc., all of which are particularly undesirable for handheld portable devices like digital cameras.

The present invention is not an exception to the underlying rules of physics, but the image creator 400 in FIG. 5 is an embodiment that especially mitigates some of the disadvantages that these rules would otherwise impose. Since the viewing screen 404 performs two roles, the expense and space saved by not using a separate optical coding unit may be applied toward providing a higher quality or larger viewing screen 404. Using the viewing screen 404 for both the user viewing and the light emitting roles may also help bring the viewed image and the printed image into harmony, although the natures of the electronic light emitters in the viewing screen 404 and of the chemical light receptors in the photoreceptive surface 134 may never permit producing images that are indistinguishable.

Two arrowed lines 408, 410 in FIG. 5 further depict the PM stock 132 traveling through the housing 406 of the image creator 400. The PM stock 132 can take many different physical forms. It can be a rigid plate-like material, resembling a photographic plate as used in old-time cameras, high quality frame cameras today, and specialized systems like X-ray machines. The PM stock 132 can also resemble more modern, flexible film and photo-paper stocks. This can include the PM stock 132 being in roll formats, somewhat like the common 35 mm and 2¼×2¼″ slide and picture films that have been widely used. The pass-through approach shown in FIG. 5 is quite suitable for this.

The photosensitive PM stock 132 can be individually stored with an opaque cover on it that can be stripped off when it is fed into the hardware the image creator 400, or it can be stored in a container and fed through the housing 406 with a transport mechanism so that only one frame or page is fed into the image creator 400 and exposed at a time. Various transport mechanisms can be used to physically move the PM stock 132, and selecting a suitable mechanism for a particular embodiment is well within the capability of one of ordinary skill in the art.

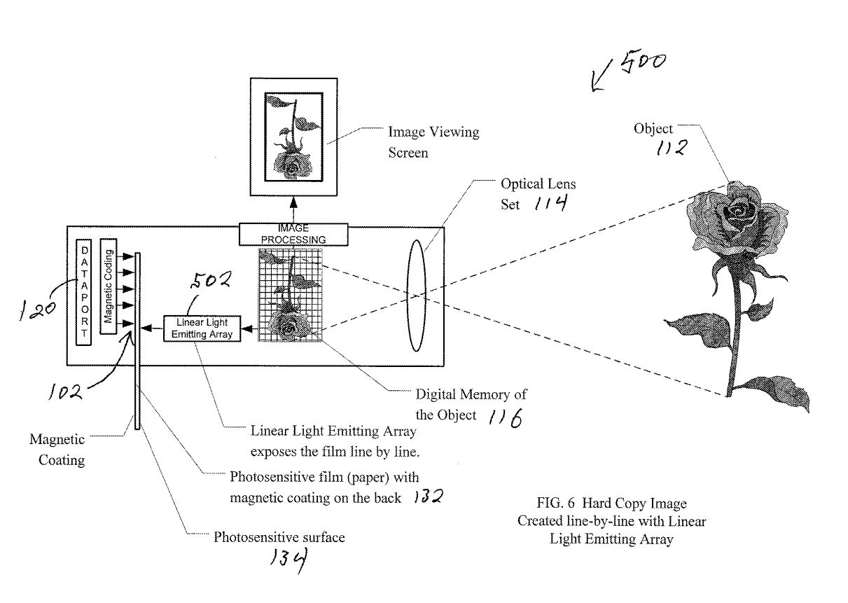

FIG. 6 is a schematic depiction of an image creator 500 that may also be used to create the PM image 102. Similar to the image creator 100 of FIG. 2, the image creator 500 is a camera-like system rather than a standalone printer-like system. Where appropriate, reference numbers are reused in FIG. 6.

The salient difference between the image creator 100 of FIG. 2 and the image creator 500 here is that the role of the planar or two-dimensional (e.g., N by M array) optical coding unit 128 of FIG. 2 is performed by a linear or one-dimensional (e.g., N cell) optical coding unit 502 (containing digitally or analog signal driven light emitting elements). To expose the photoreceptive surface 134 of the PM stock 132, either the PM stock 132 can be moved past the optical coding unit 502 or the optical coding unit 502 can be moved over the PM stock 132, exposing line-by-line until the complete PM image 102 is created. This approach can save physical size and be more economical.

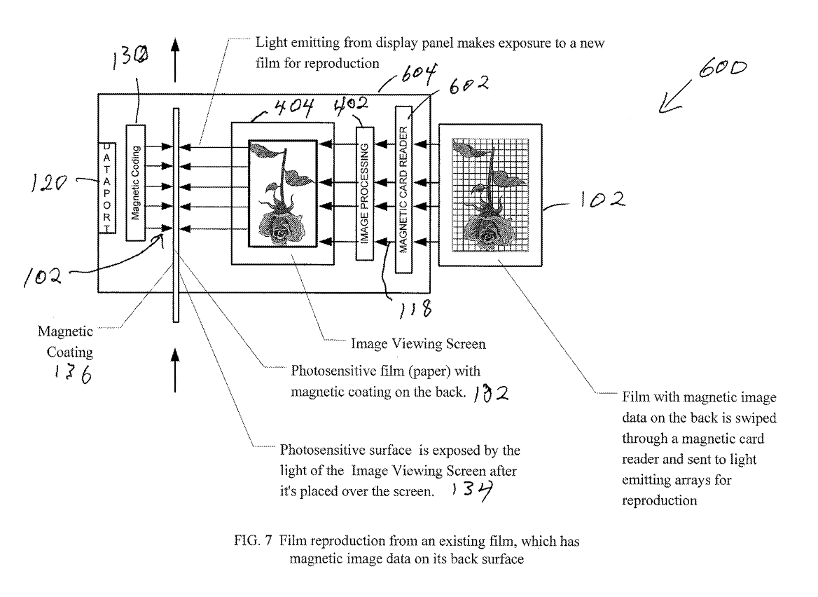

FIG. 7 is a schematic depiction of an image creator 600 that may also be used to create the PM image 102. Similar to the image creator 300 of FIG. 4 and the image creator 400 of FIG. 5, the image creator 600 is another standalone printer-like system. The image creator 600 includes a magnetic reader 602 and a housing 604, but otherwise can use elements already discussed generally for the image creator 100 or introduced with the image creator 300.

The inventor presently anticipates that most embodiments of the image creator 600 will use a swipe type magnetic card reader as the magnetic reader 602, since these readers are well known and relatively inexpensive. A user can thus simply swipe an appropriate edge of a previously magnetically “printed” PM image 102 through the magnetic reader 602 to produce a new data signal 118. Then, much as in the image creator 300, the image processor 402 receives this data signal 118 and uses it to drive the viewing screen 404. The image creator 600 can, optionally have controls to adjust image attributes of the viewing screen 404, e.g., contrast, brightness, hue, etc. and the user can adjust these as desired. Once the user is ready, the photoreceptive surface 134 of a loaded unit of the PM stock 132 is exposed, using the viewing screen 404 as the light source, and the magnetic coding unit 130 is used to “print” the magneto-receptive surface 136. The result then is a second PM image 102 that is a copy of the PM image 102 swiped through the magnetic reader 602.

The magneto-receptive surface 136 of the PM stock 132 and the magnetic reader 602 can take many forms. For example, if the magnetic reader 602 just discussed is used, the PM image 102 can have the magneto-receptive surface 136 at two or more edges and each may be swiped through the magnetic reader 602. This can be used to redundantly store the image data or to increase the storage capacity. Another variation is combine the role of the magnetic reader 602 into the magnetic coding unit 130. A user can then load an existing PM image 102 into the image creator 600 have the magnetically stored information read by the magnetic coding unit 130 and temporarily stored. The existing PM image 102 is then removed and new PM stock 132 is loaded. The temporarily stored information is then used with the image processor 402 to drive the viewing screen 404, to expose the photoreceptive surface 134 of the new PM stock 132, and this information is now used to write the magneto-receptive surface 136.

A dataport 120 is shown in the image creator 600 in FIG. 7, but this is optional. The dataport 120 here provides capabilities not found in conventional digital cameras. As the image creator 600 produces a new PM image 102 the dataport 120 can communicate the data signal 118 to an outside system, e.g., a personal computer. If the dataport 120 is chosen to have bi-directional communication capability, additional data from the outside system can be magnetically written into the magneto-receptive surface 136 of the new PM image 102. The image creator 600 also need not even produce a PM image 102. It may be used as an input device for the outside system, simply transferring the digital information from an existing PM image 102 directly into that outside system.

Up to here this discussion has largely used analogies to basic digital photography, but the present invention has broader utility and can greatly expand the capability of digital photography. Without limitation, embodiments such as that in FIG. 2 can be provided with functions to control image size, cropping, brightness, hue, rotation and flip, positive or negative image mode, color substitutions (e.g., changing background color), color range expansion and compression, false color mappings, etc. The user can view the image displayed in the viewing screen and adjust its hue or brightness, for instance, until he or she is satisfied and ready for hardcopy printing. Since the printing is conducted by exposing photosensitive paper to the light of the optical coding unit or viewing screen, processing can be accomplished in a short time. This eliminates the need to turn on a computer and printer, find proper software, and wait for the printer to warm up and complete the printing process. It also eliminates the need to stock printing supplies.

As shown in FIG. 3, embodiments of the invention can be standalone devices that perform all of the functions mentioned above. And since the hardware used can be quite compact, embodiments of the invention can even be carried around just like a camera.

The invention also has utility beyond what is currently even thought of as “digital photography.” Embodiments may be made that can optically and magnetically print anything that can be shown on a viewing screen. Using a suitable interface connector, embodiments like those shown in FIGS. 4 and 5 can receive and convert digital images from digital cameras, cellular telephones, personal digital assistants (PDAs), global position sensing (GPS) units, digital format televisions, as well as many other photographic and image creation devices. For example, a GPS produced map on a cellular phone, on a computer screen, and on a PDA can all be printed in the same manner using embodiments of this invention.

An embodiment like that shown in FIG. 5 can optionally be constructed where no interface connector is needed or used. The viewing screens of “host” systems (e.g., digital cameras, digital microscopes, digital telescopes, etc.) can be LCD flat panel displays, two-dimensional LED arrays, or even analog light sources such as a light projection panel. The image creator can be made as an attachment to these hosts, taking advantage of the existing viewing screen for light exposure of the photo-magnetic printing stock. Concurrently, other functions can be performed that the underlying host does not provide, to enhance the user's satisfaction. For instance, while the resolution of the photo-magnetic image is here limited by the resolution of the viewing screen of the attached device, changing the image attributes noted above (e.g., hue, rotation, color mapping, etc.) are now all possible.

An embodiment like that shown in FIG. 5 can also be constructed where the interface connector is used for additional purposes. For instance, since most digital cameras can store multiple photograph files, but still only some finite number of these, the image creator can be used to download only certain of those files and store them externally. The file storage unit of the digital camera can then be purged, and the files stored in the image creator written back into the file storage unit of the digital camera or into a later connected outside system. In this manner, users can back up, reorganize, and transport their digital photographs.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

1. A system for creating a photo-magnetic image of an object in photo-magnetic stock, the system comprising:
a source for a data signal that is representative of a digital image;
a first coding unit to optically write said data signal into the photo-magnetic stock; and
a second coding unit to magnetically write said data signal into the photo-magnetic stock.

2. The system of claim 1, wherein said source includes:
a lens to project an optical image of the object; and
a digital sensor to receive said optical image and generate said data signal based on said optical image.

3. The system of claim 2, wherein said digital sensor includes a digital memory array to receive and convert said optical image to memory states and to generate said data signal based on said memory states.

4. The system of claim 1, wherein said source includes an interface to receive said data signal from an external system.

5. The system of claim 4, wherein said data signal is representative of an optical image previously captured as memory states in a digital sensor in said external system.

6. The system of claim 4, wherein said data signal is representative of an optical image previously generated by said external system.

7. The system of claim 1, wherein said first coding unit includes an imaging screen to generate a recreation of said digital image to permit a user of the system to view said recreation and to selectively write said recreation into the photo-magnetic stock.

8. The system of claim 1, wherein the photo-magnetic stock is a new photo-magnetic stock and said source includes a reader to magnetically read said data signal from an old photo-magnetic stock already having the photo-magnetic image of the object, thereby duplicating the photo-magnetic image from the old photo-magnetic stock into the new photo-magnetic stock.

9. A system for creating a photo-magnetic image of an object in photo-magnetic stock, the system comprising:
providing means for providing a data signal that is representative of a digital image;
first coding means for optically writing said data signal into the photo-magnetic stock; and
second coding means for magnetically writing said data signal into the photo-magnetic stock.

10. The system of claim 9, wherein said providing means includes:
projecting means for projecting an optical image of the object; and
digital sensing means for receiving said optical image and generating said data signal based on said optical image.

11. The system of claim 9, wherein said providing means includes interface means to receive said data signal from an external system.

12. The system of claim 9, wherein the photo-magnetic stock is a new photo-magnetic stock and said providing means includes means for magnetically reading said data signal from an old photo-magnetic stock already having the photo-magnetic image of the object, thereby duplicating the photo-magnetic image from said old photo-magnetic stock into the new photo-magnetic stock.

13. A method for creating a photo-magnetic image of an object in photo-magnetic stock, the method comprising:
providing a data signal that is representative of a digital image;
optically writing said data signal into the photo-magnetic stock; and
magnetically writing said data signal into the photo-magnetic stock.

14. The method of claim 13, wherein said providing includes:
projecting an optical image of the object;
receiving said optical image onto a digital sensor; and
generating said data signal based on said optical image.

15. The method of claim 13, wherein said providing includes receiving said data signal from an external system.

16. The method of claim 15, wherein said data signal is representative of an optical image previously captured as memory states in a digital sensor in said external system.

17. The method of claim 15, wherein said data signal is representative of an optical image previously generated by said external system.

18. The system of claim 13, wherein said optically writing includes:
generating a recreation of said digital image; and
permitting a user of the system to view said recreation and to selectively write said recreation into the photo-magnetic stock.

19. The method of claim 13, wherein the photo-magnetic stock is a new photo-magnetic stock and said providing includes magnetically reading said data signal from an old photo-magnetic stock already having the photo-magnetic image of the object, thereby duplicating the photo-magnetic image from said old photo-magnetic stock into the new photo-magnetic stock.

20. A photo-magnetic image in photo-magnetic stock made by the method of claim 13.
